(19) United States
(12) Patent Application Publication
(10) Pub. No.: US 2011/0112846 A1
(43) Pub. Date: May 12, 2011

(54) System and method for support chain management and trouble ticket escalation across multiple organizations

(75) Inventor: Ray Guosheng Zhu, Fremont, CA (US)

(73) Assignee: Ray Guosheng Zhu, Fremont, CA (US)

(21) Appl. No.: 12/940,049

(22) Filed: Nov. 5, 2010

Related U.S. Application Data
(60) Provisional application No. 61/259,209, filed on Nov. 8, 2009.

(51) Int. Cl. G06Q 10/00

(52) U.S. Cl. 705/1.1

(57) ABSTRACT

A system and method for a support chain, support chain management, support case and trouble ticket escalation across multiple organizations is invented. While supply chain addresses product delivery across multiple organizations, “support chain” addresses support delivery to customers across multiple organizations. One typical support chain is formed by the partnering organizations in support case escalation path. One or more exchanges are established for organizations to become members, and through the exchanges organizations communicate with each other using their existing CRM and trouble ticket systems. Ticket Data Interchange standards are defined to govern support chain integration. For a member organization, the exchange further functions as hosted CRM or trouble ticket system, allowing the organization to centrally manage customer or user tickets, and as hosted VRM (vendor relationship management) system, allowing an organization to centrally manage vendor tickets.

### CROSS REFERENCE TO RELATED APPLICATIONS

This application claims the benefit of provisional patent application No. 61259209, filed 2009, Nov. 8 by the present inventor.

### TECHNICAL FIELD

The present invention relates generally to customer relationship management (CRM), Service Desk, Help Desk, vendor relationship management (VRM), trouble ticket management, support case management, complaint management, and internet portal.

### DESCRIPTION OF PRIOR ART

In a global economy, most products and services are provided by a chain of businesses before reaching customers. Quite often, a business is a vendor to its customers, and also a customer to its vendors; furthermore, its vendors are also customers to their upstream vendors, and its customers are also vendors to their downstream customers, and so on. For instance, AT&T is the vendor of millions of iphone customers, but a customer of Apple because AT&T purchases iphones from Apple; Apple is a vendor of AT&T, but a customer of its OEM manufacturer; the OEM manufacturer is a vendor of Apple, but a customer to many of its component vendors. Sales and order management in such a chain is known as supply chain management, and facilitated by ERP (Enterprise Resource Planning) systems and integrated across organizations via EDI (Electronic Data Interchange) and other means such as XML over the Internet.

However, the integration of supply chain is focused on sales and product delivery. Customer support is generally not part of the consideration. This is evident that the EDI X12 document list (http://en.wikipedia.org/wiki/X12 Document List) does not list any document related customer support.

While supply chain addresses product delivery across multiple organizations, how is support delivery to customers addressed?

Let's examine the current practices.

Customer Relationship Management (CRM) system is well known and used widely to handle customer support by millions of businesses for over a decade. Unfortunately,

CRM systems are not known to be forming “chains” to allow escalations outside the system. The problem is that CRM does not take into account the fact the goods sold to customers can come through a chain of upstream vendors. In other words, a CRM system is typically a “dead-end” street that offers “no-thru-traffic”.

Following the earlier iphone example, when a customer has a problem with his iphone, he or she contacts AT&T for support, AT&T would record it in AT&T CRM system. If the support case cannot be resolved within AT&T after multiple levels of internal escalations, it must be escalated to Apple, and that's when we see the “broken link”: AT&T CRM does not automatically escalate to Apple CRM system. In all likelihood, Level III support at AT&T would manually contact Apple service personnel via phone, email and fax to open a ticket with Apple CRM system, and try to get a resolution from Apple. On the AT&T side, the interactions with Apple would be recorded manually, and separate from the original AT&T customer case. From the support operation efficiency, accuracy and customer satisfaction perspective, there is apparent need to “connect” the AT&T end customer ticket with the Apple ticket.

Support is an essential function of a business, there is a need to address support delivery problem caused by dead-end CRM, and there is a need for efficient or automated “thru-traffic”.

Not only could a support ticket originate from supply chain partner, but also from internal helpdesk or service desk system. In general, a helpdesk system can be viewed as a CRM system serving internal customers—employees.

It's possible that tickets out of an internal helpdesk system are escalated to external vendors. For instance, a company employee has a broken LCD screen with his Dell laptop, he creates a ticket in the internal helpdesk system. IT staff within the organization usually calls Dell tech support, and then Dell would create a separate ticket in the Dell's CRM system. Logically, the second ticket is an escalation of the internal helpdesk ticket, but in reality, the two tickets are not automatically related or connected, but manually and mentally “linked” by IT staff. Furthermore, besides Dell, the organization may have many cases needing escalation to other vendors such as ISP, wireless, office phone, printer, servers, network vendors.

Needless to say, IT staff spends a major portion of its time processing these types of escalations manually. In the helpdesk scenario, would it be nice if IT staff could manage different escalations to different vendors in one place, instead of different email threads and “Post-it” notes?

For most organizations, the ability to provide superior customer support and service has become a critical success factor, and the mission of the business. The lack of means for support delivery and integration of support systems are costing organizations in at least two ways: The operational resources needed in support escalation; and deteriorating customer satisfaction due to delay and inaccuracy in such a manual process.

In view of the forgoing, there is a need for an improved method for support delivery which overcomes the limitations of the prior art, specifically, a system and method for escalation and management of support cases and trouble tickets across multiple organizations; support chain and support chain management. With one or more exchanges, the manual, inaccurate escalations can be fully automated.

### SUMMARY

A system and method for a support chain, support chain management, support case and trouble ticket escalation across multiple organizations is invented. While supply chain addresses product delivery across multiple organizations, “support chain” addresses support delivery to customers across multiple organizations. One typical support chain is formed by the partnering organizations in support case escalation path. One or more exchanges are established for organizations to become members, and through the exchanges organizations communicate with each other using their existing CRM and trouble ticket systems. Ticket Data Interchange standards are defined to govern support chain integration. For a member organization, the exchange further functions as hosted CRM or trouble ticket system, allowing the organization to centrally manage customer or user tickets, and as hosted VRM (vendor relationship management) system, allowing an organization to centrally manage vendor tickets.

### LIST OF FIGURES

These and other features of this invention will be more readily understood from the following detailed description of the various aspects of the invention taken in conjunction with the accompanying drawing in which:

FIG. 1 depicts a support chain across multiple organizations.

FIG. 2 depicts a detailed view of support chain for an organization.

FIG. 3 depicts a support chain implementation via a central exchange.

### DETAILED DESCRIPTION OF THE INVENTION

The present invention provides solution to support delivery and escalation across multiple organizations. Specifically, support chain, support chain management, support cases and trouble tickets escalation are discussed.

Support chain can be defined as a system of organizations, people, technology, activities, information and resources involved in delivering support to customer. While supply chain addresses product delivery across multiple organizations, support chain is the answer to support delivery across multiple organizations. One typical support chain is formed by the partnering organizations in support case escalation path.

Support chain management addresses implementation, efficiency and automation of support chain processes and standards.
For the simplicity of the discussion, and as an exemplary embodiment, the following elements and terminology are introduced or employed:
Case, ticket, incident, problem, bug, issue. For discussions in this application, these terms are used interchangeably used interchangeably.
CRM and Service Desk, Help Desk or Helpdesk. For discussions in this application, these terms are used interchangeably referring a system servicing cases and tickets for internal or external customers.
VRM, or Vendor Relationship Management. Introduced by Doc Searl at Harvard University's Berkman Center, VRM is the reciprocal of CRM, it provides customers with tools for engaging with vendors in ways that work for both parties. In this discussion, VRM is used to refer to a ticketing system used by a customer to manage multiple tickets against multiple vendors, among other VRM capabilities.
Ticket Data Interchange Standard. Similar to EDI and B2B standard for business transactions such as Purchase Order and Shipment Notification, standards are set to allow support chain systems to interoperate. Such standard includes but not limited to processes, data formats, data transmission and synchronization, protocols, specifications, etc.
Ticket Exchange. One way to implement a support chain across multiple organizations is using a centralized exchange or hub, allowing each member in the chain to connect to the exchange. The exchange implements data formats and means for data transfer according to Ticket Data Interchange Standard. More than one exchange may be used.

Referring now to the drawings:

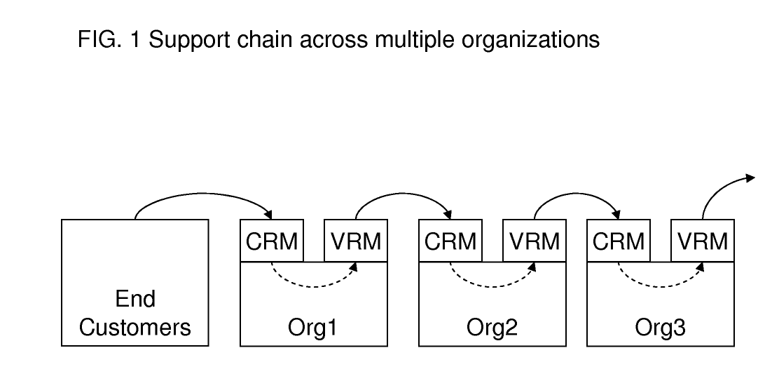

FIG. 1 depicts a support chain across multiple organizations. For obvious reasons, the “chain” resembles a train with the customers in the driver seat of the locomotive. When an end customer has an issue, it would contact the first immediate vendor (Org1) where the purchase was made, and a ticket would be created in CRM system of Org1. Org1 may determine the ticket cannot be resolved within, and must be escalated to the second vendor (Org2), which may need to further escalate to the third vendor (Org3) etc.

A vendor is not necessarily an external vendor, it could be a sister department or organizational unit within the same organization, or even an outsource support partners. A customer could be an internal sister department or individual employee.

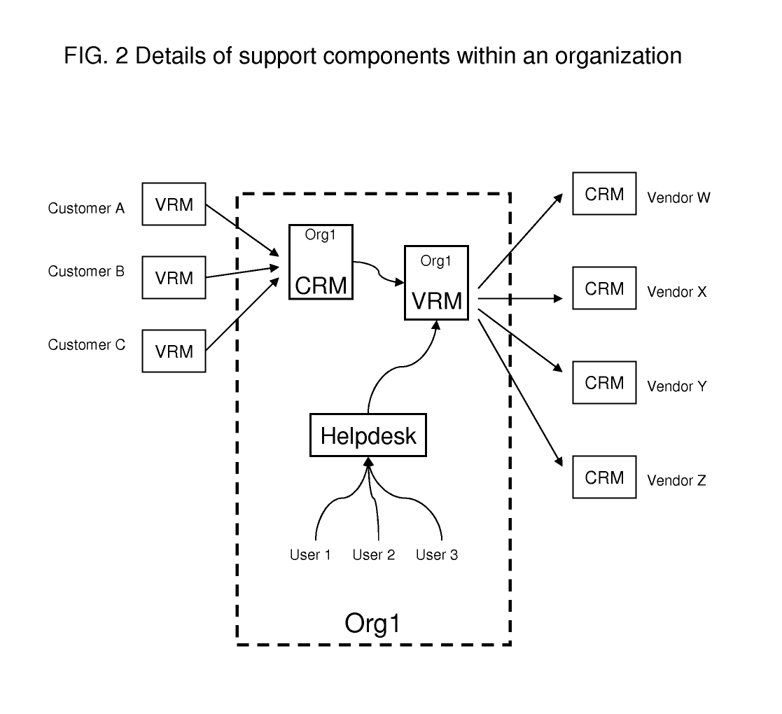

VRM in FIG. 1 is used as an external escalation interface, and will be explained in more detail in FIG. 2.

A support chain formed in FIG. 1 is with respect to a single original support ticket, follows the escalation path of the ticket. In the world of multiple customer tickets, and multiple vendors, the relationship is much more complex, as described in FIG. 2.

FIG. 2 depicts a detailed view of support chain components within an organization. An organization (Org1) may have many customers (Customer A, B, C . . . ), each of them may have own VRM that manage tickets against a plurality of vendors. All customer tickets for Org1 will be recorded in the CRM (Org1 CRM) system within Org1. As with any CRM system, customer and Org1 support representatives could have many interactions and updates to any particular ticket, and there could be multiple levels of escalation within the CRM system.

However, not all tickets are expected to be resolved and closed with the Org1 CRM system. After Org1 determines an upstream vendor may be able to resolve the ticket, Org1 CRM would escalate the ticket into Org1 VRM system.

Org1 VRM system is a centrally repository of all tickets Org1 logged against its vendors. It's also worth noting that the Org1 VRM system does not necessarily escalate to a single outside CRM to the right, instead, it allows Org1 to manage all vendor tickets in one place, and allows tickets to be updated automatically upon vendor actions when integrated.

Another source of escalation within Org1 is the Helpdesk system, which logs employee trouble tickets. When an employee's computer breaks down, he will likely log a ticket in the helpdesk system. Often, the IT support staff will need to escalate the ticket to the computer vendor for repair or replacement. Each organization deals with many different vendors, which can be managed perfectly in a VRM system.

Org1 CRM, Org1 VRM and Org1 Helpdesk are logically identified as separate, but they may physically be the same system, and even further, a ticket in the VRM system could be the same ticket in the CRM system, except that it may be flagged as escalated or outbound. Once again, A vendor is not necessarily an external vendor, it could be a sister department within the same organization, or even an outsource support partners. A customer could be an internal sister department or individual employee.

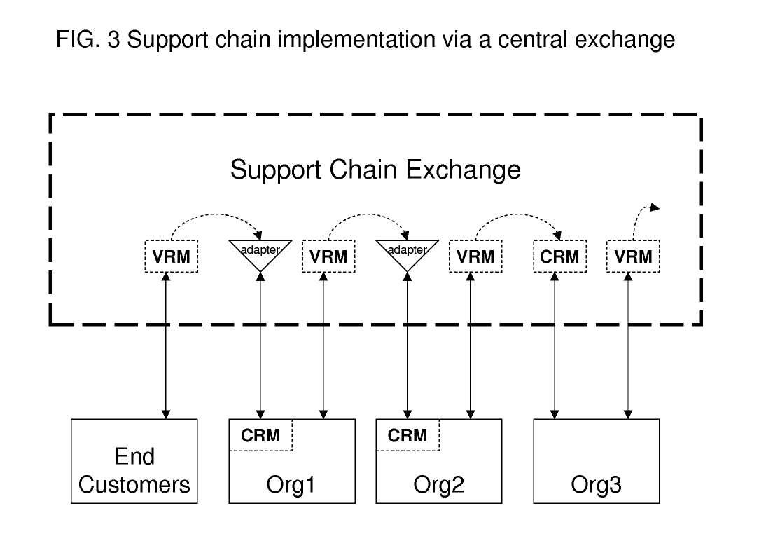

FIG. 3 depicts a support chain implementation via a central exchange. The concept and flow in FIG. 3 is the same as illustrated in FIG. 1, except that in FIG. 3, End Customer uses the exchange as VRM, and FIG. 3 provides a specific implementation.

The method in FIG. 3 uses a centralized exchange on the Internet. It provides multiple functionalities, among which: Web based access to global users, hosted VRM for organizations and individuals, hosted CRM or helpdesk system for organizations, Ticket Data Interchange Standard implementation and enforcement, and adapters allowing exchange to synchronize ticket data with existing CRM or helpdesk systems of member organizations. An adapter can be considered a custom built or packaged program that integrates two or more systems, and it may support different formats, and transformation of formats, as well as transmission protocols.

Assuming End Customers, Org1, Org2 and Org3 are members of the exchange, FIG. 3 demonstrates that:
Member organizations as well as “End Customers” can use the exchange as

VRM system
Org1 and Org2 with existing CRM or helpdesk systems can integrate with

Exchange to synchronize and escalate tickets.
Org3 without existing CRM or helpdesk system uses the Exchange as hosted

CRM or helpdesk system directly.
For an organization such as Org3, managing CRM and VRM tickets on the exchange can be as simple as two tabs in the web browser interface: “Customer Tickets” and “Vendor Tickets”, or “Inbound Tickets” and “Outbound Tickets”.

Let's examine how escalation works.

When a ticket is escalated from End Customer to Org1, then Org2, and finally Org3, the sequence of ticket escalation is as follows:
1) End Customer creates an VRM ticket use web interface provided by the Exchange.
2) Org1 CRM ticket is created, which can be the same ticket as the End Customer VRM ticket in the Exchange.
3) Org1 VRM ticket is created if Org1 CRM escalates, and is linked to Org1 CRM ticket.
4) Org2 CRM ticket is created, which can be the same ticket as Org1 VRM ticket in the Exchange.
5) Org2 VRM ticket is created if Org2 CRM escalates, is linked to Org2 CRM ticket
6) Org3 CRM ticket is created, which can be the same ticket as Org2 VRM ticket in the Exchange.

A ticket is escalated to another organization only if it cannot be resolved within the current organization.

A ticket escalated across organizations in a support chain can be resolved or closed by any organization along the support chain, and having adjacent organizations notified and updated. However, a ticket resolved by an organization may not be considered resolved by other organizations in the escalation chain, or support chain.

Let's now examine one example ticket and see how ticket closure or resolution works.

When a ticket is escalated from End Customer to Org1, then Org2, and finally Org3, and Org3 eventually resolved it. The sequence of ticket closure can happen as follows:
1) Org3 CRM ticket is closed, after Org3 provides resolution to Org2.
2) Org2 VRM ticket is closed, triggered by Org3 CRM ticket closure.
3) Org2 CRM ticket is closed, triggered by Org2 VRM ticket closure.
4) Org1 VRM ticket is closed, triggered by Org2 CRM ticket closure.
5) Org1 CRM ticket is closed, triggered by Org1 VRM ticket closure.
6) End Customer VRM ticket is closed

Note that closure of the deeper level escalation does not always lead to closure the previous level, because the previous level may not consider the issue is adequately addressed. Therefore, ticket closure at Org3 escalation level may not automatically trickle down and close end customer ticket. Different business rules may be applied by different support chain partners.

It's understood that even though the direction of escalation goes from left to right, it is also possible escalation can be reverse direction.

It is possible that organizations in the support chain integrate with one another directly, without using an exchange or hub. It's also possible to have multiple exchanges. The many exchanges can be deployed according to geography, industry segments etc.

Although the invention has been described with reference to the embodiment illustrated in the attached drawing figures, there are not intended to be exhaustive or to limit the invention to the precise form disclosed, and obviously many modifications and variations are possible in light of the above teachings. Such modifications are apparent to a person skilled in the art and are intended to be included within the scope this invention as defined by the claims.

What is claimed is:

1. A distributed case escalation and management system, comprising:
a) a plurality of case management nodes as member nodes.
b) a means for a case created in a first node to be escalated to a second node, and a means for establishing bi-directional interactions between said first node and said second node pertaining to said case, and
c) a means for said case in said second node to be escalated to a third node, and a means for establishing bi-directional interactions between said second node and said third node pertaining to said case, and so on.

2. The distributed case escalation and management system of claim 1, wherein a case management node is one of: CRM system, service desk system, help desk system, customer support system, customer service system, vendor relationship management (VRM) system, helpdesk system, incident management system, trouble ticket management system, issue management system, bug tracking system, problem management system, complaint management system, project management system.

3. The distributed case escalation and management system of claim 1, wherein a case management node is either on premise or hosted by a third party.

4. The distributed case escalation and management system of claim 1, wherein further includes one or more exchanges, comprising:
a) one or more subsystems serving as connection hubs for said case management member nodes, and
b) communication interfaces for said subsystems serving as connection hubs and said member nodes, providing connectivity and data communication for said member nodes to communicate with said subsystems serving as connection hubs.

5. The exchange of claim 4, wherein further includes a user interface providing distributed access for a plurality of users.

6. The exchange of claim 4, wherein further includes a plurality of hosted case management nodes.

7. The exchange of claim 4, wherein further includes a means for a member node to setup relationships with other members according to predetermined rules, including one or more of: visibility of said member node to other members, permissions of said member node to allow inbound escalation from other members, permissions said member node to send outbound escalation to other members.

8. The distributed case escalation and management system of claim 1, wherein further includes a means for a case in a first node to be escalated to a plurality of second nodes, and for said case in each of said second nodes to be escalated to a plurality of third nodes, and so on.

9. The distributed case escalation and management system of claim 1, wherein further includes a means for said first node to determine contents pertaining to a case to be escalated to said second node.

10. The distributed case escalation and management system of claim 1, wherein further includes a means to send automated notifications or updates to member nodes pertaining to an escalated case when said escalated case is updated by a member node.

11. The distributed case escalation and management system of claim 1, wherein further includes a means for non-member case management systems to become member nodes, and vice versa.

12. The distributed case escalation and management system of claim 1, wherein said case management nodes are owned and operated in different geographic locations by a plurality of organizations and organizational units.

13. The distributed case escalation and management system of claim 1, wherein said case management nodes are solutions provided by a plurality of vendors.

14. The distributed case escalation and management system of claim 1, wherein further includes one or more predetermined formats and protocols for data communication among member nodes.

15. The distributed case escalation and management system of claim 1, wherein the owner of a member node is one of: customer, vendor, supplier, provider, affiliate, member, partner, department, government agency, non-profit service agency.

16. A method for providing a distributed case escalation and management system, comprising
a) a plurality of case management nodes as member nodes.
b) a means for a case created in a first node to be escalated to a second node, and a means for establishing bi-directional interactions between said first node and said second node pertaining to said case, and
c) a means for said case in said second node to be escalated to a third node, and a means for establishing bi-directional interactions between said second node and said third node pertaining to said case, and so on.

17. The method of claim 16, wherein a case management node is one of: CRM system, service desk system, help desk system, customer support system, customer service system, vendor relationship management (VRM) system, helpdesk system, incident management system, trouble ticket management system, issue management system, bug tracking system, problem management system, complaint management system, project management system.

18. The method of claim 16, wherein a case management node is either on premise or hosted by a third party.

19. The method of claim 16, wherein further includes one or more exchanges, comprising:
a) one or more subsystems serving as connection hubs for said case management member nodes, and
b) communication interfaces for said subsystems serving as connection hubs and said member nodes, providing connectivity and data communication for said member nodes to communicate with said subsystems serving as connection hubs.

20. The exchange of claim 19, wherein further includes providing a user interface for distributed access for a plurality of users.

21. The exchange of claim 19, wherein further includes providing a plurality of hosted case management nodes.

22. The exchange of claim 19, wherein further includes providing a means for a member node to setup relationships with other members according to predetermined rules, including one or more of: visibility of said member node to other members, permissions of said member node to allow inbound escalation from other members, permissions said member node to send outbound escalation to other members.

23. The method of claim 16, wherein further includes providing a means for a case in a first node to be escalated to a plurality of second nodes, and for said case in each of said second nodes to be escalated to a plurality of third nodes, and so on.

24. The method of claim 16, wherein further includes providing a means for said first node to determine contents pertaining to a case to be escalated to said second node.

25. The method of claim 16, wherein further includes providing automated notifications or updates to member nodes pertaining to an escalated case when said escalated case is updated by a member node.

26. The method of claim 16, wherein further includes providing for non-member case management systems to become member nodes, and vice versa.

27. The method of claim 16, wherein said case management nodes are owned and operated in different geographic locations by a plurality of organizations and organizational units.

28. The method of claim 16, wherein said case management nodes are solutions provided by a plurality of vendors.

29. The method of claim 16, wherein further includes providing one or more predetermined formats and protocols for data communication among member nodes.

30. The method of claim 16, wherein the owner of a member node is one of customer, vendor, supplier, provider, affiliate, member, partner, department, government agency, non-profit service agency.
